(19) United States
(12) Patent Application Publication
(10) Pub. No.: US 2026/0036171 A1
(43) Pub. Date: Feb. 5, 2026

(54) HUB-BEARING UNIT FOR A VEHICLE WHEEL

(71) Applicant: AKTIEBOLAGET SKF, GOTEBORG (SE)

(72) Inventors: Ivan MAURO, Bricherasio (IT); Daniele DUCH, San Gillio (IT); Gianni Alvise COGNOLATO, Trofarello (IT); Marco GEMELLO, Nichelino (IT)

(21) Appl. No.: 19/280,190

(22) Filed: Jul. 25, 2025

(30) Foreign Application Priority Data
Aug. 1, 2024 (IT) 102024000018100

(51) Int. Cl. F16C 33/76; F16C 19/18

(52) U.S. Cl. CPC F16C 33/768; F16C 19/185; F16C 2326/02

(57) ABSTRACT

A hub-bearing unit having an axis of rotation includes a radially outer ring configured to be stationary, a flanged hub inside the radially outer ring configured to rotate relative to the axis and relative to the radially outer ring, a radially inner ring mounted on the flanged hub in axial abutment with a shoulder of the flanged hub, a front toothing configured to receive a driving torque from a joint, and a retainer configured to receive and form a snap fit seal with an elastic ring connected to the joint, the retainer being located on a radially external cylindrical surface of the radially inner ring and comprising a shaped metal insert and an elastomeric element vulcanized onto the metal insert.

### CROSS-REFERENCE

This application claims priority to Italian patent application no. 102024000018100 filed on Aug. 1, 2024, the contents of which are fully incorporated herein by reference.

### TECHNOLOGICAL FIELD

The present disclosure relates to a hub-bearing unit for a driving wheel of a motor vehicle.

### BACKGROUND

According to the prior art, a hub-bearing unit comprises a flanged rotatable hub connected to a rotating element of a vehicle, for example a wheel or a brake disc, and a bearing unit comprising an outer ring and two inner rings. A first one of the inner rings is formed by the flanged hub itself and a second one of the inner rings is a separate component mounted on the flanged hub. The unit also includes a plurality of rolling bodies, for example balls, between the inner and outer rings.

By means of a process known as orbital rolling, an axially internal end part of the flanged hub is deformed in order to grip the second radially inner ring onto the flanged hub itself.

The driving torque of the vehicle is transferred to the hub-bearing unit by means of a constant-velocity joint, a bell member of which is angularly coupled to the hub-bearing unit itself by means of a front gearing. The front gearing comprises a front toothing formed on the axially internal end part of the flanged hub, after it has been deformed, and a front toothing formed on the bell member.

The axial coupling between the bell member of the joint and the hub by means of front toothing is a delicate operation: if the two components are not angularly in phase with each other there are consequent problems of engagement between the two sets of front toothing, namely there is the risk of binding occurring between the teeth of the front toothing of the hub and the teeth of the front toothing of the bell member. This results in unacceptable noise and vibrations during use.

A further problem is the retention of the joint during the process of assembly with the hub-bearing unit before the two components are rigidly connected together by means of the element for fixing the joint itself.

In order to overcome this drawback, some motor vehicle manufacturers require that a combined axial assembly of the hub and the bell member, angularly-in-phase, be provided and maintained in phase by means of an elastic ring which snap engages onto a component of the hub-bearing unit.

It is therefore necessary to design a hub-bearing unit which is able to solve the technical problem of retention and snap-engagement of the elastic ring and, at the same time, ensure a static seal with regard to the elastic ring of the joint in order to protect the front toothing.

A known solution is that of the incorporating the geometry which ensures retention and snap-engagement of the elastic ring into the design of the inner ring mounted on the flanged hub. This solution, however, has various drawbacks. First, the inner ring provided with a raceway for the rolling bodies must necessarily be made of a material with a high hardness, for example tempered steel. Therefore the production of the geometry for interface with the elastic ring is difficult and costly. Also, the retention geometry formed on the ring must necessarily have a projecting form and must be provided with a groove for housing the tooth of the elastic ring. Owing to the presence of this groove, the corresponding resistant section of the inner ring will therefore have a projecting form and reduced thickness with the consequent risk of premature breakages. Another problem is that it is required to provide a minimum clearance between the retention geometry formed on the inner ring and the geometry of the front toothing of the hub, and this solution does not ensure the static seal with the elastic ring of the joint. Inn any case, the process for producing the front toothing of the hub is very complicated owing to the limited radial play between the toothing and the retention geometry of the inner ring.

### SUMMARY

An aspect of the present invention is to provide a hub-bearing unit which does not have the aforementioned drawbacks.

A first aspect of the disclosure comprises a hub-bearing unit having an axis of rotation and also having a radially outer ring configured to be stationary, a flanged hub inside the radially outer ring and configured to rotate relative to the axis and relative to the radially outer ring, a radially inner ring mounted on the flanged hub in axial abutment with a shoulder of the flanged hub, a front toothing configured to receive a driving torque from a joint, and a retainer configured to receive and form a snap fit seal with an elastic ring connected to the joint, the retainer being located on a radially external cylindrical surface of the radially inner ring and comprising a shaped metal insert and an elastomeric element vulcanized onto the metal insert.

In addition, the metal insert may comprise a cylindrical assembly portion press fit onto a radially outer surface of the radially inner ring, the cylindrical assembly portion having an axially outer end and an axially inner end, an annular abutment portion extending radially inward from the axial inner end of the assembly portion and abutting against an axially facing annular surface of the inner ring, a cylindrical secondary portion projecting axially inward from a radially inner end of the abutment portion, and a support portion at the axially inner end of the cylindrical secondary portion.

Furthermore, the elastomeric element may comprise a hook configured to block axial movement of the elastic ring of the joint in the axially inward direction, and a static sealing lip extending axially inwards and radially outwards from the support portion and being configured to contact with a surface of the joint to create a static seal.

### BRIEF DESCRIPTION OF THE DRAWINGS

The disclosure will now be described with reference to the attached drawings which illustrate a non-limiting example of embodiment thereof, in which:

FIG. 1 is a cross-sectional view of a hub-bearing unit according to a first preferred embodiment of the present disclosure.

FIG. 2 is a detail of a portion of the hub-bearing unit according to FIG. 1 on a larger scale.

FIG. 3 is a detail view of a portion of the hub-bearing unit according to a second embodiment of the present disclosure.

### DETAILED DESCRIPTION

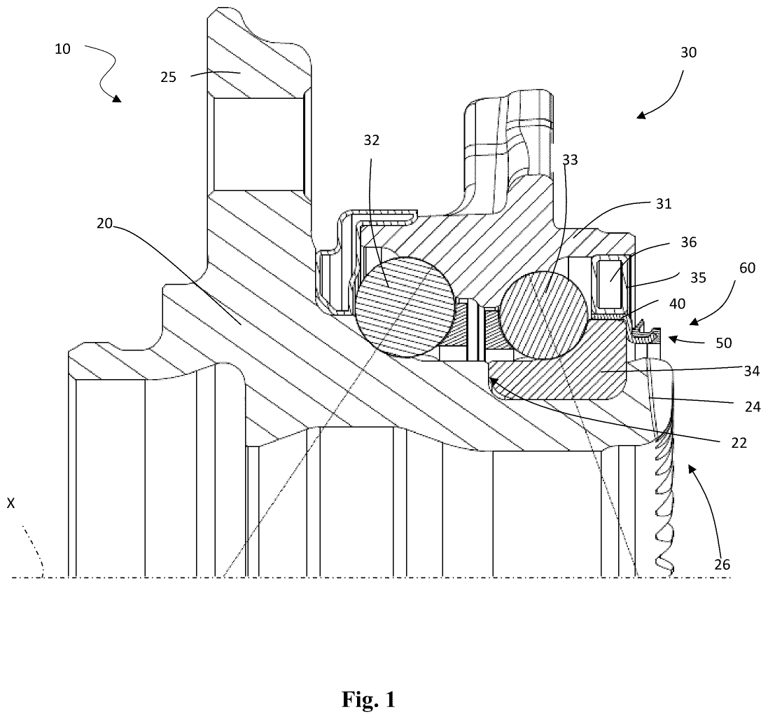

With reference to FIG. 1, reference numeral 10 identifies an overall hub-bearing unit according to a first preferred embodiment of the disclosure.

The hub-bearing unit 10 is arranged, during use, between a wheel and a chassis, both known and not shown, of the vehicle and can be selectively coupled to a constant-velocity joint, known and not shown and not forming part of the present disclosure, by means of a transmission device, also known and not shown, for the transmission or non-transmission of the driving torque to the respective wheel (not shown).

The hub-bearing unit comprises a rotatable flanged hub 20 and a bearing unit 30 having a central axis of rotation X. The bearing unit includes a radially outer ring 31 which is stationary, and a radially inner ring 20 defined by the flanged hub 20 and a further radially inner ring 34 mounted on, and integral with, the flanged hub 20, both the radially inner rings 20, 34 being rotatable with respect to the radially outer ring 31 owing to the arrangement, in between, of two rows of rolling bodies 32, 33, in this case balls. The bearing device also includes a sealing device 35 configured to seal an annular interspace 36 between the outer ring 31 and the inner ring 34.

In all of the present description and in the claims, the terms and the expressions indicating positions and orientations such as “radial” and “axial” are understood as being in relation to the central axis of rotation X of the bearing unit 30. Expressions such as “axially external” and “axially internal” refer to the assembled condition of the hub-bearing unit and, in the case in question, preferably are in relation to a wheel side and, respectively, a side opposite to the wheel side.

The flanged hub 20 has a flange 25 on an axially external side for fixing to the hub-bearing unit 10 of the wheel of the vehicle and, on an axially internal side thereof, an end edge 24 which has been rolled by an orbital rolling process and which is configured to axially preload the inner ring 34 against the radially outer shoulder 22 of the flanged hub 20.

At the same time as the orbital rolling process or after the process, a front annular toothing 26 is formed on the edge 24 and is configured to receive the driving torque transmitted from the constant-velocity joint by means of a respective toothing formed on the bell member of the joint.

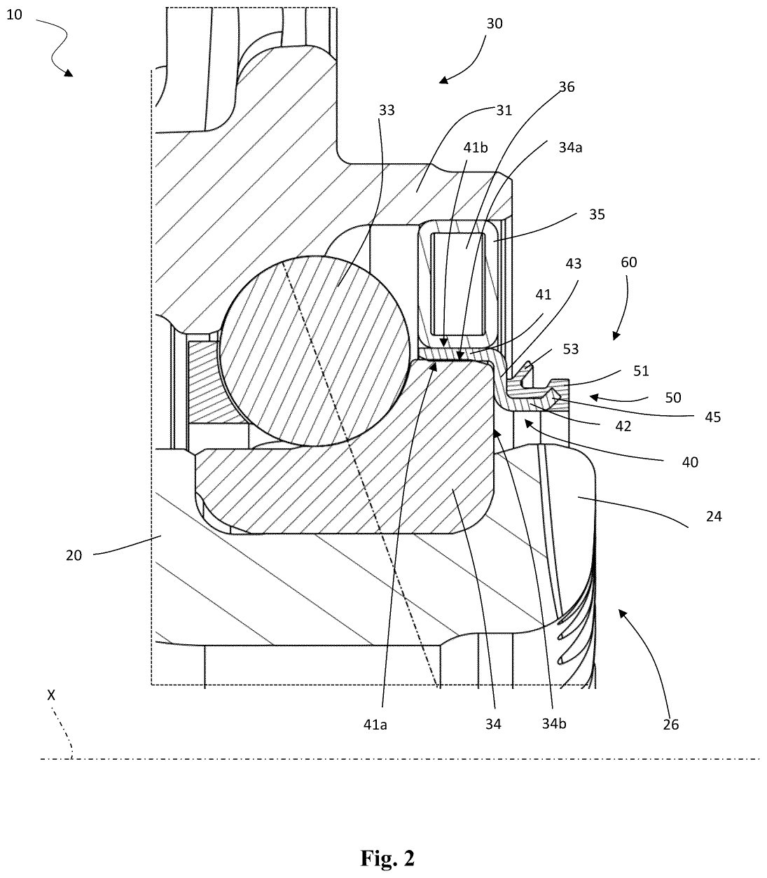

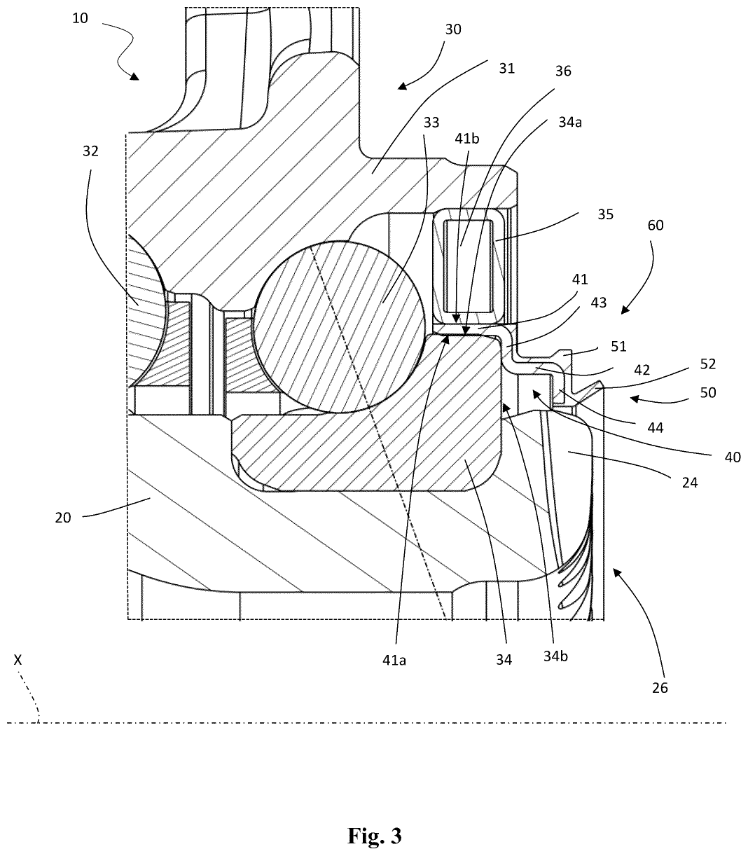

According to the disclosure and with reference also to FIGS. 2 and 3, the hub-bearing unit 10 provided with the front toothing 26 includes a sealing and snap-retention device 60, sometimes referred to hereinafter as a retainer, which engages with an elastic ring of the constant-velocity joint.

The device 60 could have axial symmetry with respect to the axis X and be radially arranged between the inner ring 34 and the sealing device 35. In particular, the device 60 is assembled with an interference fit on a radially outer cylindrical surface 34a of the inner ring 34 and supports the sealing device 35 by means of a press fit so as to ensure the static sealing of the sealing device itself.

The sealing and snap-retention device 60 according to the disclosure may be realized as different embodiments, for example the two embodiments shown in FIG. 2 and FIG. 3, respectively. In both embodiments, the device 60 comprises a shaped metal insert 40, which is preferably made of pressed sheet metal, and an elastomeric element 50 vulcanized onto the metal insert 40.

The metal insert 40 comprises a cylindrical assembly portion 41, arranged radially between the inner ring 34 and the sealing device 35 and assembled with an interference fit on the surface 34a of the inner ring 34 by means of a first, radially inner, cylindrical surface 41a thereof being in contact with the surface 34a of the inner ring 34. The assembly portion 41 also has a second, radially outer, cylindrical surface 41b in contact with the sealing device 35. The metal insert 40 also includes an annular abutment portion 43 abutting against an annular surface 34b of the inner ring 34 and connected to the assembly portion 41 and a cylindrical secondary portion 42 axially projecting from the abutment portion 43, to which it is connected, and in a position radially more internal with respect to the assembly portion 41. The cylindrical portion 43 has an axial length which depends on the axial dimension of the elastic ring of the joint. The metal insert 40 also includes a support portion 44 or a support portion 45, which is connected to the cylindrical portion 43 and is axially internal with respect thereto and the geometry and function of which varies depending on the two embodiments.

The elastomeric element 50 comprises a hook 51, which is preferably cylindrical and has the function of snap-retention of the elastic ring of the joint and a static sealing lip 52 or a static sealing lip 53, which extends axially inwards, but also radially outwards, namely has a frustoconical form, and is designed to come into contact with a surface of the joint so as to create a static seal for protection also of the front toothing.

With particular reference to FIG. 2, in the first embodiment of the device 60, the support portion 45 is frustoconical and has the function of supporting the hook 51 and giving it rigidity. The static sealing lip 53 is axially external with respect to the hook 51, namely is arranged between the inner ring 34 and the hook 51.

With particular reference to FIG. 3, in the second embodiment of the device 60, the support portion 44 is annular and has the function of supporting the lip 52 of the elastomeric element 50. The static sealing lip 52 is axially internal with respect to the hook 51 and the inner ring 34.

In the two embodiments, the different axial position of the static sealing lips in a different position serves to ensure contact with different surfaces of the joint, situated in different zones depending on the interface of the specific application.

Advantageously, the elastomeric element 50 of the sealing and snap-retention device 60 could comprise both the lip 52, axially internal with respect to the hook 51 and the lip 53 axially external with respect to the hook 51.

Also advantageously, the roughness of the two cylindrical surfaces 41a, 41b of the assembly portion 41 must be between 0.1 Ra and 3.2 Ra. In fact, as regards the first cylindrical surface 41a, the precision required by the interference fit between the retention ring 40 and the inner ring 34 necessarily requires the presence of a low roughness value in that zone and in any case a value of not more than 3.2 Ra. The second cylindrical surface 41b also requires a low roughness value since, in the case of high values of more than 3.2 Ra, the sealing device 35 might not be able to guarantee the static seal.

The metal insert 40, as already mentioned, is preferably made of pressed sheet metal and may have a thickness of between 0.4 mm and 2 mm. Alternatively, the insert 40 may be a pressed or machined component. In this latter case, the thickness of the assembly portion 41 of the insert 40 is preferably greater than 0.8 mm, this value being the minimum value needed for this component to be machined.

From the point of view of the process, the interference assembly of the sealing and snap-retention device 60 will be performed after the operation of orbital rolling of the end edge 24 of the flanged hub 20 and formation of the front toothing 26. In fact, if assembly of the device is performed before to the aforementioned operations, the metal insert 40 of the device 60 could interfere with the rolling and tooth-forming tools. In order therefore for these operations to be possible it would be necessary to increase the play between the insert 40 and the front toothing 25 so that the tools do not come into contact with the insert itself. Instead, by performing assembly of the device 60 after the rolling and tooth-forming operations, it is possible to reduce to a minimum the play between the toothing and the metal insert 40, with the advantage that the radial dimensions of the hub-bearing unit may be kept small.

To summarize, the present disclosure solves the technical problem posed, by ensuring meshing of the front toothing of the hub and joint without the risk of binding occurring between the teeth of the respective toothing. The present disclosure also solves the problem of retention of the joint during the process of assembly together with the hub-bearing unit. Furthermore, owing to the introduction of the sealing and snap-retention device, the inner ring is simpler to produce since it does not require the retention geometry, the design of the snap-retention geometry is much more flexible since it is realized on a special component, separate from the inner ring, and the same device, without the need for further components, also performs the function of ensuring a static seal with the joint.

In addition to the embodiment of the disclosure, as described above, it must be understood that there exist numerous other variants. It must also be understood that these embodiments are only examples and do not limit either the scope of the disclosure, nor its applications, nor its possible configurations. On the contrary, although the description above allows the person skilled in the art to implement the present disclosure at least according to one of its examples of embodiment, it must be understood that many variants of the components described are possible, without thereby departing from the scope of the disclosure, as defined in the accompanying claims, interpreted literally and/or in accordance with their legal equivalents.

What is claimed is:

1. A hub-bearing unit having an axis of rotation and comprising:
a radially outer ring configured to be stationary;
a flanged hub inside the radially outer ring and configured to rotate relative to the axis and relative to the radially outer ring;
a radially inner ring mounted on the flanged hub in axial abutment with a shoulder of the flanged hub;
a front toothing configured to receive a driving torque from a joint; and
a retainer configured to receive and form a snap fit seal with an elastic ring connected to the joint, the retainer being mounted on a radially outer cylindrical surface of the radially inner ring and comprising a shaped metal insert and an elastomeric element vulcanized onto the metal insert.

2. The hub-bearing unit according to claim 1, wherein the metal insert comprises:
a cylindrical assembly portion press fit onto the radially outer surface of the radially inner ring, the cylindrical assembly portion having an axially outer end and an axially inner end,
an annular abutment portion extending radially inward from the axial inner end of the assembly portion and abutting against an axially facing annular surface of the inner ring,
a cylindrical secondary portion projecting axially inward from a radially inner end of the abutment portion, and
a support portion at the axially inner end of the cylindrical secondary portion.

3. The hub-bearing unit according to claim 2, wherein the elastomeric element comprises:
a hook configured to block axial movement of the elastic ring of the joint in the axially inward direction; and
a static sealing lip extending axially inwards and radially outwards from the support portion and being configured to contact with a surface of the joint to create a static seal.

4. The hub-bearing unit according to claim 3, wherein the support portion is frustoconical supports the hook.

5. The hub-bearing unit according to claim 2, wherein the elastomeric element comprises:
a static sealing lip extending axially inwards and radially outwards from the support portion and being configured to contact with a surface of the joint to create a static seal.

6. The hub-bearing unit according to claim 3, wherein the support portion is annular and supports the static sealing lip.

7. The hub-bearing unit according to claim 6, wherein the static sealing lip extends axially inwardly or axially outwardly from the hook.

8. The hub-bearing unit according to claim 2, wherein the assembly portion has a radially inner cylindrical surface in contact with the radially outer surface of the radially inner ring and has a radially outer cylindrical surface.

9. The hub-bearing unit according to claim 2, wherein the insert is made of metal.

10. The hub bearing unit according to claim 3,
wherein the cylindrical secondary portion surrounds and is radially spaced from a flange of the flanged hub.

11. The hub bearing unit according to claim 10,
wherein the hook surrounds and is radially spaced from the flange of the flanged hub.

12. The hub bearing unit according to claim 11,
wherein the hook is located radially inward of an imaginary cylinder bounding a radially outer surface of the radially inner ring.

13. The hub bearing unit according to claim 12,
including a seal unit mounted on a radially outer surface of the cylindrical assembly portion and contacting the radially outer ring.
